(19) United States
(12) Patent Application Publication
(10) Pub. No.: US 2009/0132994 A1
(43) Pub. Date: May 21, 2009

(54) AUTOMATION TOOL AND METHOD FOR GENERATING TEST CODE

(75) Inventors: John D. Doggett, Redmond, WA (US); Jan Turecek, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/941,084

(22) Filed: Nov. 16, 2007

(51) Int. Cl. G06F 9/44

(52) U.S. Cl. 717/106

(57) ABSTRACT

An automation tool for generating test code to test a UI is disclosed. In embodiments disclosed, the automation tool includes a recording function and a generator component. In illustrating embodiments, the recording function includes a processing component and a collector component for processing an input dialogue and collecting data associated with the input dialogue or events. As shown, the generator component invokes methods or procedures of a generator class to generate code.

### BACKGROUND

Computer devices typically include a user interface (UI) to interact with one or more applications or programs. An example user interface is a graphical user interface generated on a display device such a display screen or monitor. A user interacts with the user interface via various input devices such as a keyboard, keypad, mouse or other input device to activate functions or features of the user interface. During use, it is important that the user interface execute actions corresponding to the activated function or features of the user interface.

Operation of the user interface is typically tested during development or during later use. Prior test applications typically provide a UI specific test platform. The UI specific test platform is not typically adaptable to changes in the UI. Additionally, prior test platforms do not provide a record of the recorded dialogue to facilitate repeat testing of the same test input or dialogue.

The discussion above is merely provided for general background information and is not intended to be used as an aid in determining the scope of the claimed subject matter.

### SUMMARY

Embodiments of the application disclose an automation tool for generating test input or code for a UI for a dialogue exchange between a user or tester and a computer generated user interface UI. In embodiments disclosed, the automation tool includes a recording function and a generator component. In illustrated embodiments, the recording function includes a processing component and a collector component for processing an input dialogue and collecting data associated with the input dialogue. The generator component utilizes an object based code generator to generate UI test code for a recorded dialogue and data. The generated test code includes calls to invoke methods to implement specific UI actions of the user dialogue and in illustrated embodiments is used to replay the dialogue or exchange.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a schematic illustration of a user interface for an application or program.

FIG. 2 schematically illustrates an embodiment of an automation tool as described in the application.

FIG. 3 is a flow chart illustrating an embodiment of recording and collector components of the automation tool illustrated in FIG. 2.

FIG. 4 schematically illustrates an embodiment of a generator component for generating UI test code.

FIG. 5 is a flow chart illustrating generating procedures of an embodiment of a generator component of the automation tool illustrated in FIG. 2.

FIG. 6 illustrates an embodiment of a generator component configured to generate a look-up localized string object for an input string.

### DETAILED DESCRIPTION

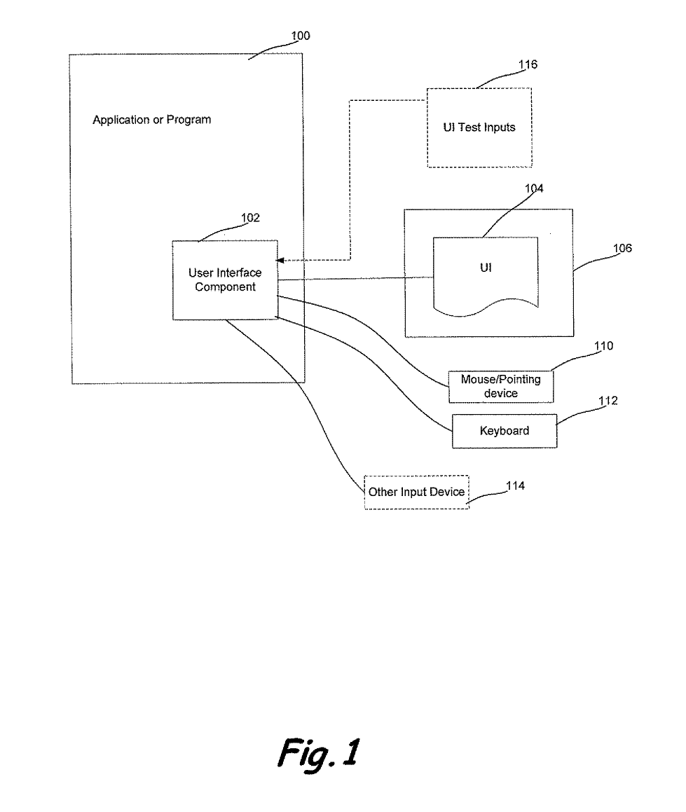

FIG. 1 illustrates an application or program 100 implementable on a computer device. In the illustrated embodiment, the application or program 100 includes a user interface component 102 that generates a user interface, such as a graphical user interface on a display device 104 such as a monitor 106 to allow the user to interact with the application or program. Illustratively, a user interacts with the application through the user interface using a mouse 110, a keyboard 112 or other input device 114 as schematically shown. For example, the mouse is used to position a cursor on the user interface 104 and one or more of the buttons (not shown) on the mouse 110 are used to select or activate functions of the user interface. During use, a user can implement a sequence of one or more events or inputs (collectively referred to a UI dialogue) to implement or control various functions or features of the application 100.

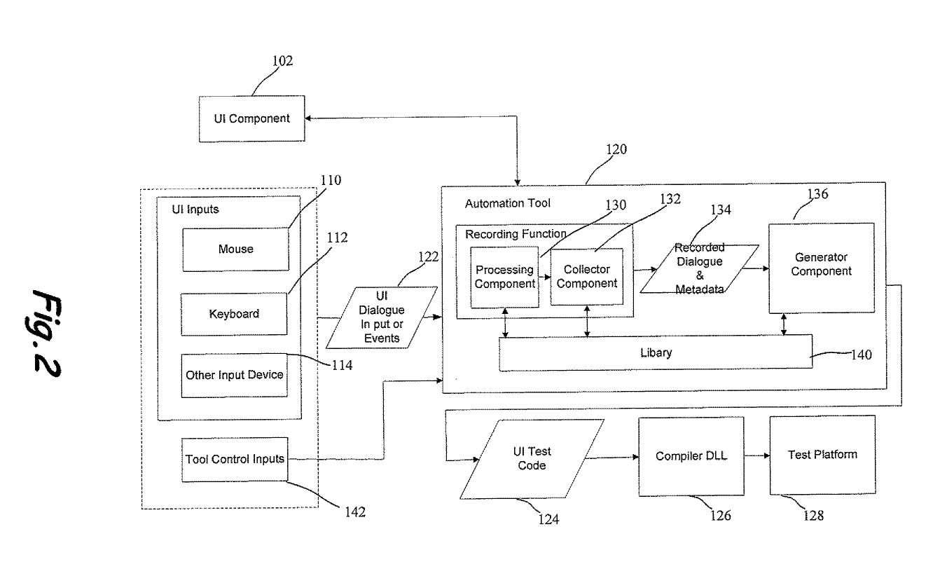

During development, operation of the user interface is typically tested using test inputs 116 as schematically illustrated in FIG. 1. Embodiments described herein relate to an automation tool 120 as shown in FIG. 2 for automatically generating test inputs 116 for testing a user interface 104 of an application or program 100. The test inputs 116 are generated via a dialogue exchange between a user or tester and a computer generated UI. The dialogue exchange includes one or more events activated through input devices 110, 112, 114. The tool 120 has application for generating test code for the dialogue exchange for testing the UI of various applications, such as operating system applications.

In the embodiment illustrated in FIG. 2, the automation tool 120 is configured to generate code in response to UI inputs or events activated or selected via input devices 110, 112, 114. As shown, in FIG. 2, a user activates a sequence of functions or controls on the user interface via input devices 110, 112, 114 to provide a dialogue input 122 including one or more events to the automation tool 120. The automation tool 120 is configured to generate UI test code 124 corresponding to the selected functions or controls. As shown, the UI test code 124 is compiled by a compiler 126 for execution on a test platform 128 to provide input 116 for testing operations of the user interface 104 of the application or program.

In the illustrated embodiment shown, the automation tool 120 includes a recording function which is used to record a test dialogue exchange. As shown, the recording function includes a processing component 130 and a collector component 132. The processing component 130 processes the dialogue input 122 to determine the control types for UI inputs or events. The collection component 132 is configured to retrieve data or information based upon the control type or class of the events or inputs of the UI dialogue exchange. The recorded dialogue of events and associated metadata 134 is outputted to a computer readable file or data store.

As shown, the automation tool 120 of FIG. 2 includes a generator component 136, which receives the recorded dialogue and metadata 134 and generates the UI test code 124 for implementation through the test platform 128. The test code can be generated in any programming language, such as C#, C++ or other programming language. As shown, the automation tool 120 accesses control objects and data in a library 140 to implement the recording and generation functions of the automation tool 120 as described in more detail herein. Operation of the automation tool 120 is controlled via various tool control inputs (or hotkeys) 142.

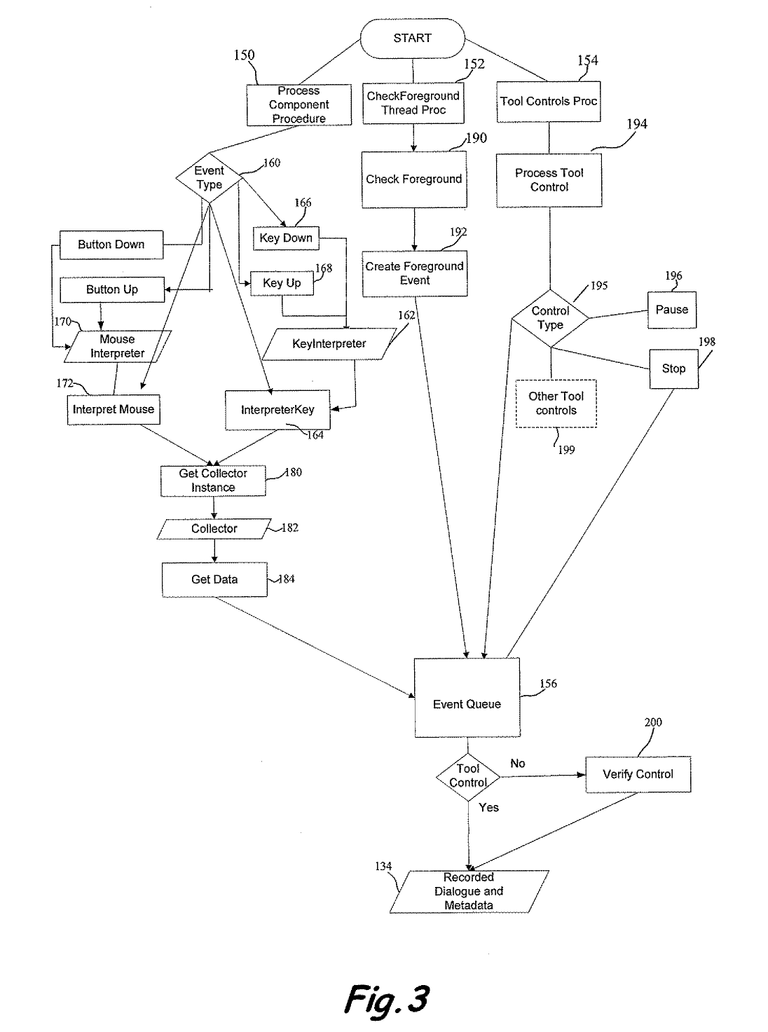

FIG. 3 is a detailed flow chart illustrating an embodiment of the recording function of the automation tool 120. In the embodiment illustrated in FIG. 3, the recording function activates multiple thread procedures including a processing thread 150, a checkforeground procedure 152 and a tool control procedure 154 as shown. Output from each of the threads is provided to an event queue 156 to generate the recorded dialogue and data 134 for the input dialogue or events.

As shown in FIG. 3, the processing thread 150 processes the dialogue input or events to determine the event or control type as illustrated at decision block 160. If the event or control type 160 is a keystroke, the processor generates a KeyInterpreter object 162 that invokes interpretkey methods 164 to interpret keystrokes such as “keydown” 166 or “Keyup” 168 to ascertain the control or function of the keystokes or combination of keystrokes. For example, if the input or event is for a keydown and then a keyup, the keystrokes are interpreted by the interpreting methods 164 as a “press” function or control type. If the event type is a mouse input, the processing thread 150 creates a mouseinterpreter object 170 which invokes Interpretmouse methods or procedures 172 to interpret the control type or function of the mouse (or other pointing device) such as a “click”, “click and hold” and “click and drag”.

Also as shown in FIG. 3, the processing procedure invokes Getcollectorinstance 180 to generate a collector instance 182 corresponding to the particular control type or class. The collector instance 182 invokes Getdata methods 184 to collect or get data specific to the control type or class. For example, if the type is a list view, the Getdata methods 184 retrieve data specific for the list view or other keystroke function or action. The data and the objects for the events are added to queue 156 to generate the recorded dialogue exchange and meta data 134 as previously described.

In the checkforeground thread 152, the tool checks if the foreground of the UI has changed as illustrated by checkforeground procedure 190. If the foreground has changed, checkforeground procedure 190 creates a foreground change event, which is added to queue 156. The foreground change event is used to generate code that provides an interrupt or pause to synchronize execution of the UI with UI changes when the test code is used to test or replay the user dialogue.

The tool control procedures 154 determine if any of the tool control inputs have been activated or selected. If a tool control has been selected or activated, the tool control is processed by procedure 194. The tool control is processed to determine the tool control type as illustrated by decision block 195. Depending upon the tool control type, a particular tool control procedure is used to generate an event for the queue 156.

In the particular embodiment shown, the tool control inputs include stop and pause inputs. Upon activation of the stop input, the tool control procedure activates a stop control procedure that adds a stop event to the event queue as shown. Alternatively upon activation of other tool controls various other events are added to the event queue 156. In the illustrated embodiment shown in FIG. 3, the events in the queue 156 are processed by a verify control function or procedure 200 to assure that the necessary generator class or functions for the recorded dialogue and metadata are supported by the library and tool.

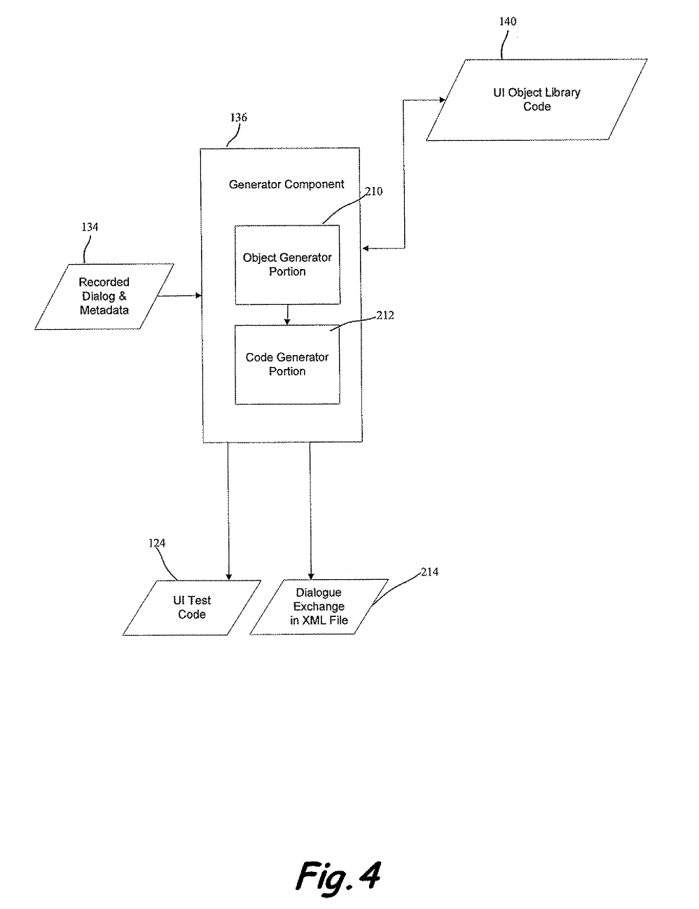

FIG. 4 illustrates functions of the generator component 136. As shown, the generator component 136 includes an object generator portion 210 and a code generator portion 212. The object generator portion 210 generates library objects for particular control types or events. The code generator portion 212 generates code to invoke methods or actions corresponding to one or more input events of the dialogue exchange between the user and the computer generated UI. In the illustrated embodiment, the generator component 136 outputs the UI test code 124 and a Dialogue Exchange in XML file 214. The XML output provides a snapshot of the recorded dialogue and data which can be processed by the generator component 136 to regenerate the test code to replay the UI dialogue exchange at a later time. Although a particular output is shown, application is not limited to the particular output shown.

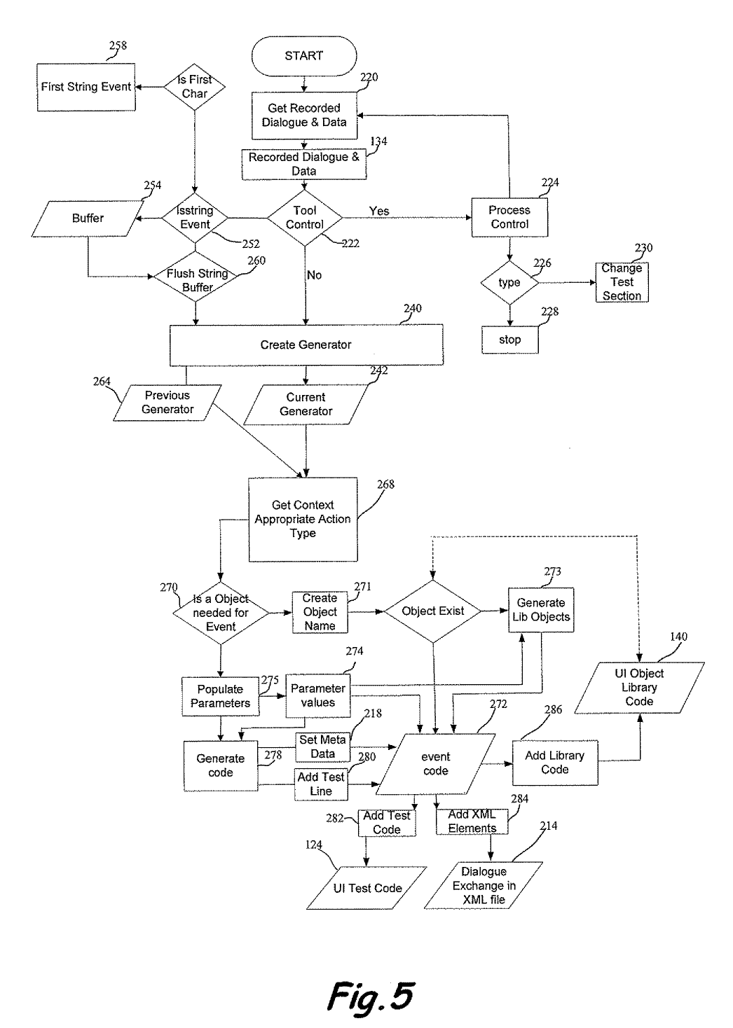

FIG. 5 is a flow chart illustrating operation of an embodiment of the generator component 136. As shown, the generator component 136 initiates a GetRecorded dialogue and data procedure 220 to retrieve the recorded dialogue and data 134. As illustrated in decision block 222, the generator component 136 determines if the event of the dialogue or data is a tool control. If the event is a tool control, the tool control is processed by a process control function 224 to determine the type of tool control as illustrated by decision block 226. Depending upon the tool control, various procedures are activated corresponding to the tool control type.

In the illustrated embodiment, the tool control procedures include a stop procedure 228 and change test section procedure 230. Although illustrated tool controls are disclosed in the application, other tool controls and implementing procedures can be used and application is not limited to the particular tool controls described.

If the event is not a tool control, A create generator procedure “Create Generator” 240 is invoked to create a currgenerator object 242 for a particular control or event type to implement code generating procedures based upon the control class or type. The create generator procedure 240 uses a table or other structure to map the control classes to a generator class. The create generator procedure 240 tries to find the most appropriate generator class for the control type based upon the data provided by the collector.

In an illustrated example, if the UI dialogue includes a “button click” event, the generator component would invoke a button generator class. In another illustrated example, if the UI dialogue exchange includes a “list view” event, a list view generator class is invoked.

As illustrated in FIG. 5, procedures of the generator component 136 use a “Get Action Type” procedure 268 to determine the action type for the event of the UI dialogue based upon the generator class. For example, if the generator class is a button generator class, the action type includes “click”, “click and drag”, or “press”. Other generator classes have different action types, which are supported by the class.

As illustrated in decision block 270, the generator procedures determine if an object is necessary for the event based upon the generator class or action type. Some events such as a foreground change do not require an object. If the object is needed, a Createobject name method 271 is invoked to generate an object name for event code 272. The event code 272 is a class which bundles the objects, data and code to invoke the UI actions of the dialogue exchange.

If the object for the class exist in the library 140, the generator procedures use the existing object from the library 140 to generate the event code 272. Otherwise, if the object does not exist in the library 140, the object generator portion 210 (shown in FIG. 4) generates objects for the event via a generate objects procedure 273 shown in FIG. 5.

As illustrated, parameters values 274 for the event or class are populated by a populate parameter procedure 275. As shown, the generate objects procedure 273 uses the parameter values to generate the object for the event code 272. The generate code procedures 278 create code to call methods to invoke the context appropriate actions based upon the class and action type. If no appropriate action method is found for the control type a generic click( ) or sendkey( ) method is used depending upon the event type. The generate code procedures 278 generate the meta data 218 and lines of code 280 to invoke context appropriate actions of the dialogue exchange.

In the illustrated embodiment, the event code 272 is used to generate the UI test code 124 via an add test code procedure 282. Also, the event code 272 is used to generate the XML file or output 214 via an add XML elements procedure 284. As shown in FIG. 5, the objects generated by the generate objects procedure 273 are added to the library 140 via an add library code procedure 286. In an illustrated embodiment, the generator component 136 includes one or more templates to generate different code based upon the requirements of the test platform 128. For example, in an illustrated embodiment, the generator component 136 includes a first template to generate UI test code in a first programming language such as C# and a second template to generate UI test code in a second programming language such as C++.

If the event is a string event as illustrated by decision block 252 (for example a readable character is entered into a textbox), the component adds the characters of the string to a buffer 254 and saves the event as a FirstString event 258. Each successive string event (e.g. each additional character entered into the same textbox) is then added to the string buffer 254. When the string is complete (for example the textbox loses focus), a generator “Previous Generator” 264 is created via create generator procedure 240 using both the saved Firststring event 258 and the string buffer 254 as illustrated by flush string buffer 260. Create Generator 240 also creates generator “CurrentGenerator” 242 for the current event or action on the string (for example the event is the click which resulted in the textbox losing focus. Both the Current generator 242 and Previous generator 264 are used to generate the event code 272 or the UI test code 124 as previously described.

As described, the UI object library code 140 provides an abstract layer separate from the UI test code 124 that models the UI component 102. The generation component 136 can reuse objects from the UI Object Library code 140 for subsequent code generation. Since the UI test code 124 utilizes the abstract UI object library code 140, the test code 124 is adaptable to changes in the UI via changes to the UI object library code 140.

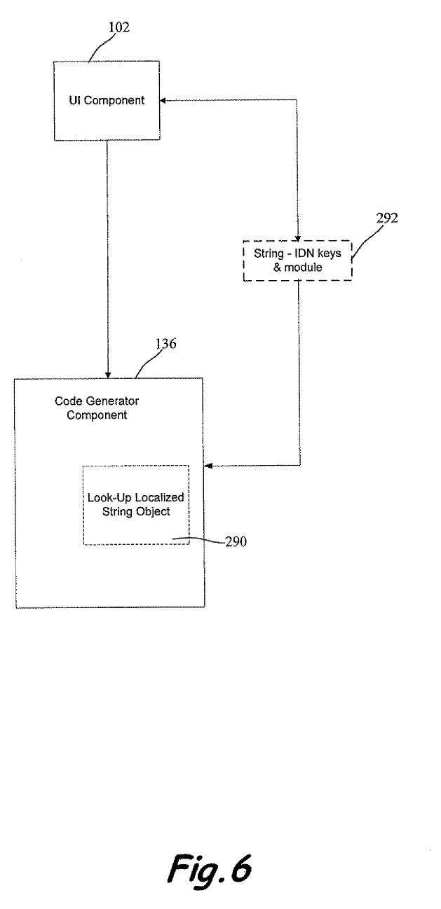

In an embodiment illustrated in FIG. 6, the generator component 136 creates a look-up localized string object, which is resolved at run-time. The look-up localized string object is resolved using a string IDN keys 292 retrieved at run-time. This provides a language independent platform for testing.

As described, the tool enables the creation of test automation quickly. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An application tool implementable on a computer readable medium comprising:
a generator component configured to receive a UI dialogue exchange and generate output test code for an event of the UI dialogue exchange that invokes one or more UI actions corresponding to the event utilizing objects and methods from a library.

2. The application tool of claim 1 wherein the generator component includes an object generator portion configured to generate library objects for use by code generating procedures to generate the output test code.

3. The application tool of claim 2 wherein the library objects are added to the library.

4. The application tool of claim 1 wherein the generator component creates a generator class corresponding to the event and methods of the generator class are invoked to generate the test code for the event.

5. The application tool of claim 1 wherein the dialogue exchange includes input from a user input device configured to interface with the UI.

6. The application tool of claim 5 wherein the input device is a mouse or keyboard.

7. The application tool of claim 1 wherein the application tool includes a recorder configured to receive the dialogue exchange and the recorder includes a collector component configured to collect data based upon a control type of the event to generate a recorded dialogue and data.

8. The application tool of claim 3 wherein the generator component uses the library objects added to the library to generate the output test code.

9. The application tool of claim 1 wherein the generator component comprises a first template to generate code in a first programming language and a second template to generate code in a second programming language.

10. A method implementable on a computer readable medium comprising:
receiving input from a user input device and UI component and recording one or more events of a user interface dialogue exchange;
processing the one or more events to determine a control type;
invoking a collector object for the control type and collecting data associated with the control type; and
outputting the one or more events and the associated data to a computer readable file or data store.

11. The method of claim 10 wherein the processing comprises utilizing interpreter methods or procedures to interpret input from a keyboard or pointing device or mouse.

12. The method of claim 10 wherein collecting data comprises instantiating a collector and invoking collector methods to collect the data for the control type.

13. The method of claim 10 and further comprising
checking a foreground of a UI to a detect foreground change;
generating a foreground change event in response to the detected foreground change; and
adding the foreground change event to an event queue.

14. The method of claim 10 and comprising;
utilizing library objects and methods from a library to generate code for the dialogue exchange.

15. A method comprising:
recording a dialogue exchange for a user interface including one or more events including actions invoked through a user input device; and
utilizing objects and methods from a library to generate code for the dialogue exchange.

16. The method of claim 15 and comprising:
generating one or more objects based upon a control type of the one or more events; and
adding the one or more objects to the library.

17. The method of claim 15 wherein and comprising:
generating an XML file of the dialogue exchange; and
generating test code from the XML file to replay the dialogue exchange.

18. The method of claim 15 and comprising:
creating a generator class corresponding to a control type of the one or more events; and
using methods of a generator class to generate the code.

19. The method of claim 15 wherein the objects and methods model the UI from which the dialogue exchange was recorded and comprising:
changing the library objects and methods to adapt to changes in the UI.

20. The method of claim 15 and comprising utilizing a look-up localized string object and resolving the look-up localized string object at runtime.
